(19) United States
(12) Patent Application Publication
(10) Pub. No.: US 2005/0205577 A1
(43) Pub. Date: Sep. 22, 2005

(54) Cookware lid assembly with sealing band and whistling handle

(76) Inventor: SoonKwan Park, InChon (KR)

Correspondence Address: LATHROP & GAGE LC, 2345 GRAND AVENUE, SUITE 2800, KANSAS CITY, MO, 64108, US

(21) Appl. No.: 10/801,777

(22) Filed: Mar. 16, 2004

(51) Int. Cl. B65D 51/16; A47J 29/00

(52) U.S. Cl. 220/367.1; 220/912; 220/756

(57) ABSTRACT

A cookware lid assembly having a whistling handle and a removable flexible sealing band that extends around a flange on the lid. The sealing band secures the lid to the cookware to prevent the lid from being dislodged from the cookware as pressure inside the cookware increases or as water in the cookware comes to a boil. The handle has a hole in it that generates as whistling noise when the pressure in the cookware increases. A movable slide in the handle allows the hole in the lid to be closed or remain fully or partly open. The slide also allows the volume and pitch of the whistle to be adjusted.

### FIELD OF INVENTION

The field of this invention is cookware lids.

### BACKGROUND OF INVENTION

Cookware lids are placed on pots, pans, saucepans, and other cookware to retain heat when food is being cooked in the cookware. The lid retains heat inside the cookware and causes the contents to heat more quickly during the cooking process.

Frequently water is placed in the pot, pan, saucepan, or other cookware piece, the food to be cooked is placed in the water or other liquid in the pan, and the pan is placed on a heated stove to heat the contents. On other occasions, water is placed in the pan, the pan and water are heated on the stove until a cooking temperature is reached, and the food is then placed in the heated water to cook. In either case, it is necessary to reduce the heat on the stove once the water boils so that the water does not boil or spill out of the pan.

The contents of the pan will reach boiling or cooking temperature more quickly if a lid is placed on the pan to prevent heat from escaping. As the contents of the cookware are heated to higher temperatures, the water in the cookware produces pressurized air, water vapor, and/or steam. When the water in the pan comes to a boil, or as the pressure inside the cookware increases, the lid can be dislodged from the top of the pan, which results in hot water (or other liquid, if something other than water is being heated) boiling or splattering over and out of the pan. When water boils over or out of the pan the liquid contents of the pan can spill on the stove and even onto the floor. In addition, a danger is created for persons in the vicinity of the stove, who may come into contact with the boiling water. In some cases the lid may be even be dislodged enough to be forced off the pan by the pressurized air, water vapor, and/or steam. In order to avoid such a boil over, it is necessary to reduce the heat applied to the pan at the time, or just before, the water begins to boil.

Prior art lids have whistling devices, some of which are quite complicated. However, such prior art lids do not have means to keep the lid firmly on the cookware when the liquid contents of the cookware boil. If the lid of a prior art cookware item initially has a snug fit, it can become loose by the expansion of the cookware when it is being heated, or it can become loose or leaky if the pan becomes bent or distorted from use. Many prior art lids also have handles that cannot be disassembled easily for cleaning, and most prior art lids do not incorporate devices that make a whistling sound of a desired volume. Although prior art cookware/lid combinations may permit a lid to be mechanically locked on the cookware, such as by a snap-fit clamp or the like, none have been observed with lids that have inexpensive, disposable sealing bands that may be securely affixed or expanded around the rim of a lid and accommodate both irregularities in the shape of the lid rim or cookware rim and different rates of expansion of the lid and cookware rim during heating. None of the prior art lids have the combined features of a handle/whistle device that makes an audible sound, such as a whistle, to signal when the liquid contents have reached a boil; that is easy to disassemble, clean, and reassemble; that permits regulation of the volume of the sound produced by the whistle or signal; that has a snug, sealed fit; that has a removable, disposable sealing band that fits around the rim structure of the lid and accommodates for irregularities in the shape of the lid and rim and unequal expansion of the lid and cookware during heating

### OBJECTS OF INVENTION

The objects of this invention are to provide a lid for a pot, pan, saucepan, or other cookware that will prevent the water from boiling over or out of the cookware; that will not become dislodged from the cookware when the water or other liquid in the pan comes to a boil, or when the pressurized air, water vapor, and/or steam in the cookware increases; that will make a whistling noise that will signal when the water in the pan is boiling so that the user can reduce the heat applied to the cookware; that will allow the user to adjust the volume of the whistling sound the lid makes when the liquid contents begin to boil or the pressure inside the cookware increases; that has a handle that is easy to disassemble, clean, reassemble to the lid; that has a handle that is uncomplicated and inexpensive to make; and that utilizes an inexpensive, disposable sealing band that seals the lid on the cookware and accommodates both irregularities in the shapes of the lid and cookware and unequal expansion rates of the lid and cookware during heating.

### SUMMARY OF INVENTION

The lid assembly of the invention comprises a lid, a handle, a handle base or mount, a threaded handle retainer, and a disposable, replaceable silicone sealing band.

The lid, which may be made of metal or glass, has an outer rim made of metal or other suitable material, and a central hole through its top. A flange extends downward from the rim.

The handle forms a central longitudinal hole or cavity that narrows, or is smaller in diameter, near the upper part of the handle. The lower, larger portion of the hole in the handle is threaded.

One end of an elongated slide is pivotably attached to a pin inside the handle. An opposite end of the slide extends outward through a slot in the side of the handle and ends in a grip that is grasped or pushed to pivot the slide about the pin. A mid portion of the slide forms a hole. When the slide is pivoted via the grip, the hole in the slide may be brought into register with the narrowed portion of hole in the handle, out of register with the narrowed portion of the hole in the handle, or partly into register with the narrowed portion of hole in the handle.

The handle may be placed on top of a base or mount that conforms to the contour of the lid. The base or mount has a hole that, when the handle is installed on the lid, is on top of the hole in the center of the lid.

A exteriorly threaded retainer, which also has a central longitudinal hole, connects the handle, the handle mount or base, and the lid to one another. The lid is assembled by placing the handle mount on the top of the lid so that the hole in the handle mount is above the hole in the lid. The handle is then placed on top of the handle mount so that the hole through the center of the handle is in register with the holes in the lid and the mount. From the underside of the lid, the threaded retainer is then inserted up into the registered holes of the lid, mount, and handle and screwed into the threaded portion of the hole in the center of the handle until it is secure.

So assembled, the central longitudinal hole in the retainer extends from the bottom of the lid to the slide and is in register with the narrower or smaller diameter portion of the hole in the upper part of the handle. The slide may be moved so that the hole in its mid portion is in register with the central longitudinal hole in the retainer and the narrowed portion of the hole in the upper part of the handle. When the lid is placed on the pan and the holes are so aligned, the registered holes form a single, combined cavity or hole that extends from the inside of the pan up through the top of the handle.

The single, combined cavity or hole may be closed or blocked by moving the slide so that the hole in the mid portion of the slide is out of register with the hole in the upper part of the handle. If the slide is moved so that the hole in the slide is only partly in register with the holes in the retainer and the top of the lid, there is a single combined cavity that extends from the inside of the pan to and through the top of the handle, but the combined cavity or hole is partially closed off or narrowed in the area of the slide.

When the lid is to be used during cooking, a replaceable silicone band is placed around the flange of the lid. Cooking liquid, which is usually water, is placed in the pan (with or without the food to be cooked), and the lid is placed on the pan. The band on the flange of the lid causes the lid to fit snugly on the pan and seal the lid on the pan. The pan is then placed on an energized stove to heat the contents. The slide is moved via its grip so that the hole in the slide is fully or partly in register with the hole in the upper part of the handle and the hole in the retainer.

When the cooking liquid is heating sufficiently to boil and/or produce pressurized air, water vapor, and/or steam, the pressurized air, steam, and/or water vapor move upward through the aligned holes (i.e., the combined, single hole) through the retainer, slide, and the upper part of handle. Although pressure is built up in the pan when the cooking liquid reaches a boil or produces pressurized air, steam, and/or water vapor, the lid does not become dislodged from the pan, because the lid is securely and snugly sealed to pan by the silicone band. Instead, the pressurized air, steam, and/or water vapor escape through the hole in the slide and up through the hole in the upper part of the handle to the atmosphere. As the air, steam, and/or water vapor pass through the combined hole in the retainer, slide, and handle, a whistling sound is produced.

The whistling sound alerts the user to reduce the heat on the stove for the balance of the cooking process. The desired volume of the whistling sound may be preset (or set after the whistling sound begins) by moving the slide so that the hole through which the steam and water vapor is narrowed or widened, a wider hole producing a louder whistling sound and a narrower hole producing a quieter whistling sound.

### DRAWINGS

FIG. 1 is a top plan view of the lid and handle of the invention.

FIG. 2 is a side view of the lid, handle, and band of the invention.

FIG. 3 is an exploded view of the lid, handle, and band.

FIG. 4 is a partial cross-sectional view of the handle and lid with the slide of the handle in the open, whistling position.

FIG. 5 is a partial cross-sectional view of the handle and lid with the slide of the handle in a closed position.

FIG. 6 is a partial cross-sectional of the handle showing the slide in an open position.

FIG. 7 is a partial cross-sectional of the handle showing the slide in the closed position

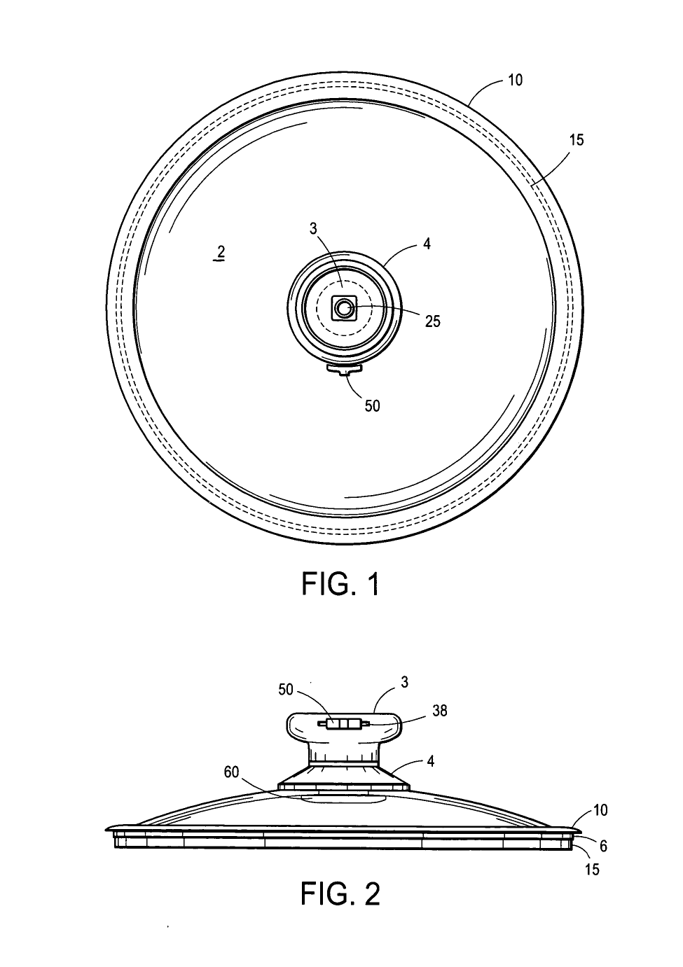

### DETAILED DESCRIPTION OF INVENTION

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. The drawings constitute a part of this specification and include exemplary embodiments of the present invention and illustrate various objects and features thereof.

The following convention is used in describing various directions with respect to the inventive lid. The pan or cookware on which the lid is placed is assumed to be setting on a counter or other surface in an upright position for normal use. When the lid and cookware are in this upright, normal orientation, the following terms have the following meanings: The terms “up” or “upward” mean the vertical direction extending from the bottom of the cookware toward the top of the cookware and beyond; the terms “down” or “downward” mean the vertical direction that is the opposite of the “up” or “upward” direction—i.e., the vertical direction extending from the top of the cookware toward the bottom of the cookware; the terms “in” or “inward” means the horizontal direction from the periphery or side of the cookware toward the center of the cookware; and the terms “out” or “outward” means the opposite horizontal direction—i.e., the direction from the center of the cookware toward the periphery or side of the cookware. If a part or object is “above” another part or object, the part or object is in a position or location that is in the upward direction from the other part or object; thus, the lid of the cookware is above the bottom of the cookware when the cookware is in its normal upright position; similarly if a part or object is “below” another part or object, the part or object is in a position that is in the downward direction from the other part or object; thus, the bottom of the cookware is below the lid of the cooker when the cooker is in its normal upright position.

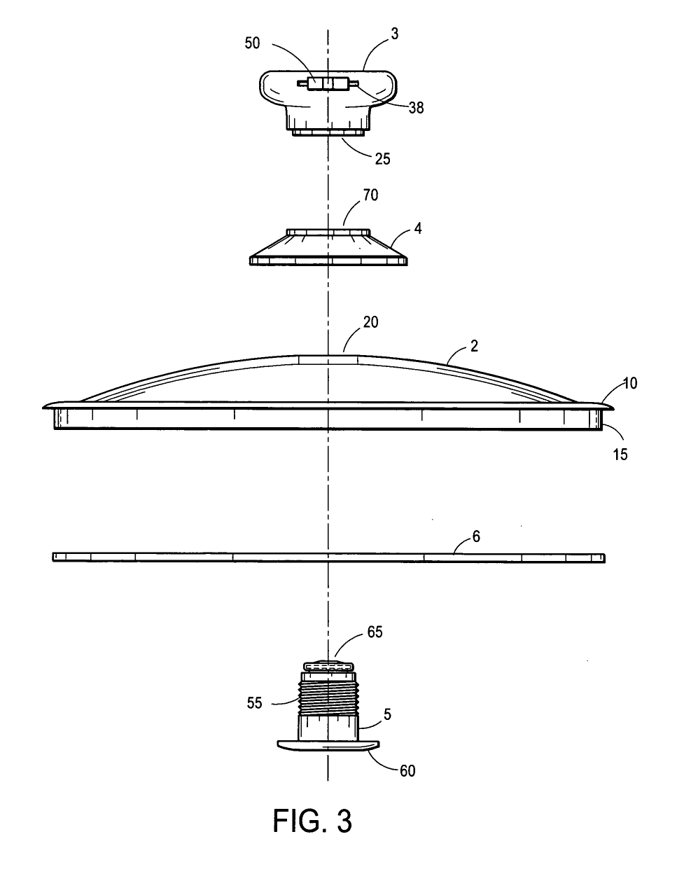

FIGS. 2 and 3 show a lid assembly 1 for use on pots, pans, saucepans, and other cookware (not shown). The lid assembly 1 comprises a lid 2, a handle 3, a handle mount 4, a handle retainer 5, and a silicone band 6.

The lid 2 may be made of glass, metal, or some other suitable material that can withstand heating. The lid 2 has a rim 10 and a flange 15 that extends downward from the rim 10 and is sized to fit within the top of the pan (not shown) on which the lid assembly 1 is to be used. If the lid 2 is made of glass, as show in FIGS. 2 and 3, the rim 10 may be made of metal, and the flange 15 may be formed as part of the rim 10. If the lid 2 is made of metal or some other heat-stable substance the flange 15 may be formed as part of the lid 2 when it is fabricated. The lid 2 forms a central hole 20 in its top or crest.

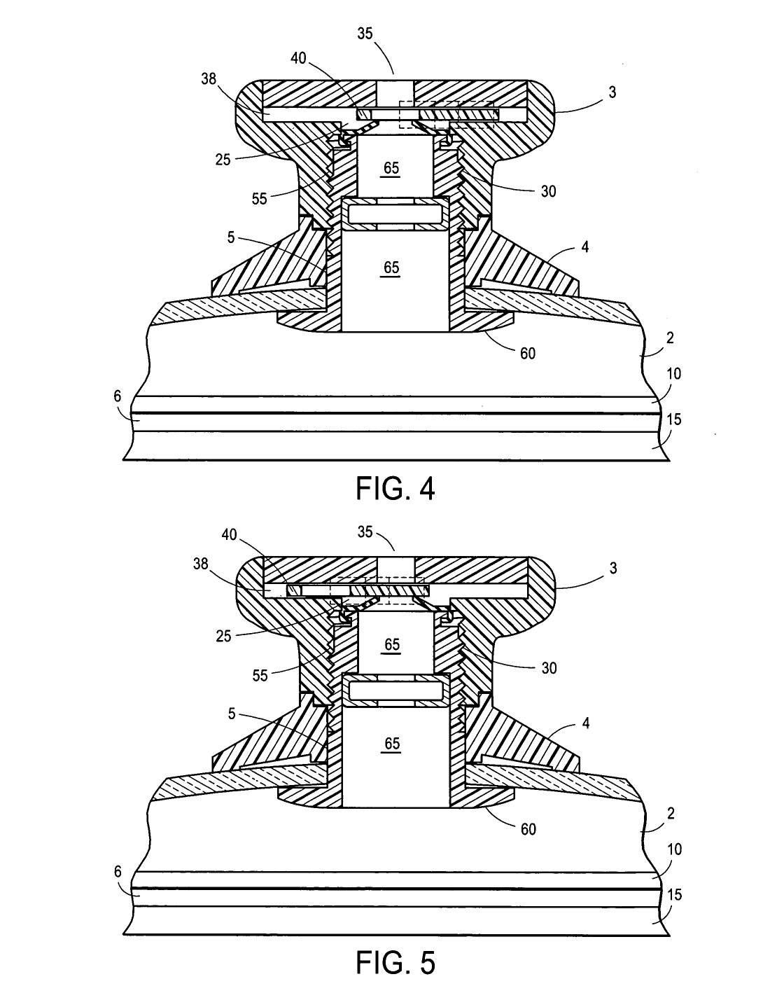

The handle 3 may be made of metal, plastic, or some other material that is a less efficient conductor of heat so that the handle remains cooler than the lid 2 or the pan when the pan and its contents are being heated. The handle 2 forms a central longitudinal hole 25 that has threads 30 as shown in FIGS. 4 and 5. An upper part 35 of the hole 25 is narrower or smaller in diameter than the lower part of the hole 25 that is threaded. The handle 2 also forms a slot 38 in its side below the narrower or smaller diameter hole 25, as shown in FIGS. 2 through 7.

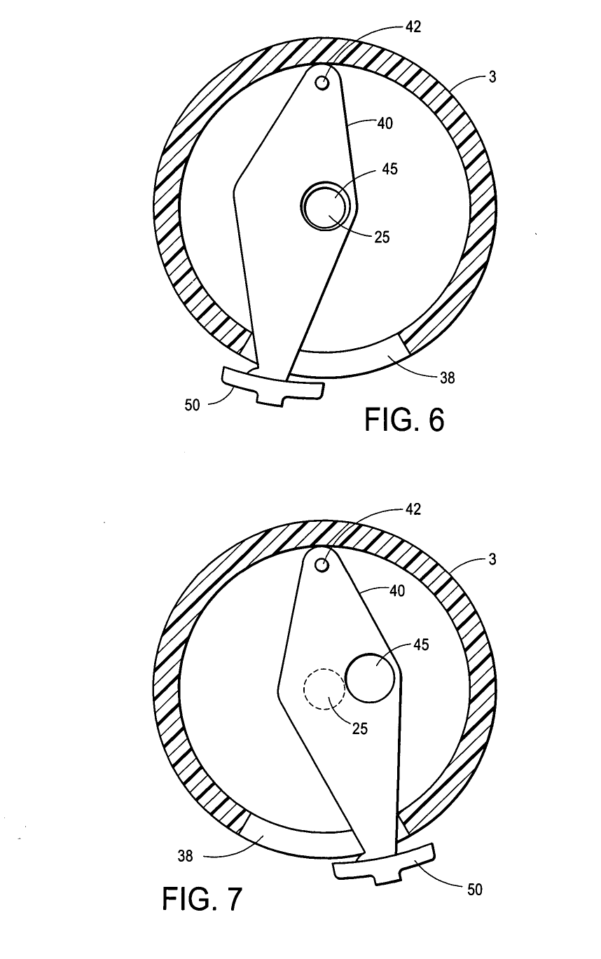

As shown in FIGS. 6 and 7, one end of an elongated slide 40 is attached to the inside of the handle 2 by a pin 42 so that the slide 40 can be pivoted horizontally about the pin 42. A hole 45 is formed in slide 40 in a location such that, when the slide 40 is moved horizontally about the pin 42, the hole 45 may moved to a position immediately below the narrower part 35 of the hole 25 in the handle. The opposite end of the slide 40 extends outward through slot 38 and forms a grip 50 that may be pushed or grasped from the outside of the handle 2 to move the slide 40 horizontally about pin 42, thus moving the hole 45 in the slide 40 into or out of register with the upper, narrower part 35 of the hole 25 in the handle 2.

As best shown in FIG. 3, the outside of retainer 5 is threaded such that its threads 55 match the internal threads 30 of the hole 25 in the handle 3. The retainer 5 may thus be screwed into the hole 25 of the handle. The retainer 5 also has a base 60 that can be used to screw the retainer into the hole 25 in the interior of the handle 3 and anchor the retainer 5 against the underside of the lid 2 when the retainer 5 is threaded into the hole 25. The retainer 5 has an interior hole 65 which communicates with the interior of the cookware and the narrowed portion 35 of the hole 25 in the handle 3.

As shown in FIGS. 3, 4, and 5, the handle mount 4 is used to space the handle 3 from the top of the lid 2 and fully cover the hole 25 in the lid 2 when the lid assembly 1 is fully assembled. It would, of course, be possible to make the handle mount 4 an integral part of the handle 3, or to eliminate the mount 4 entirely, provided suitable means were used to seal and protect the hole 25 in the lid when the handle 3 and the lid 2 are fully assembled. The handle mount 4 has an internal hole 70 so that the retainer 5 may be inserted into and through the mount 4 and threaded into the hole 25 in the handle 3.

As shown in FIGS. 2 and 3, the lid assembly 1 may be assembled by inserting the retainer 5 up thought the hole 20 in the lid 2 until the retainer base is flush with and anchored against the underside of the lid 2. The handle mount 4 is then placed on the top of the lid 2 so that the threaded portion 55 of the retainer 5 extends up through the hole 20 in the handle mount 4. The handle 3 is then threaded or screwed onto the threaded retainer 5 until it is tight, thus securing the retainer 5, the mount 4, and the handle 3 to the lid 2.

When the lid 2 is ready for use, the flexible silicone band 6 is placed around the flange 15 of the lid 2. The lid 2 is then placed on the top of the cookware, the silicone band 6 sealing the lid 2 on the top of the cookware. So assembled, the interior hole 65 of the retainer extends from the inside of the cookware up to the narrowed portion 35 of the handle 3, ending just below the slide 40 in the handle 3. The slide 40 may then be pivoted by pushing the grip 50 of the slide 40 until the hole 45 in the slide 40 is in register with and immediately above the hole 65 in the retainer 5 and in register with and immediately below the narrowed portion 35 of the hole 25 in the handle 3. If desired, the slide 40 may be pivoted in the manner described above so the hole 45 in the slide 40 is only partially in register with the hole 65 in the retainer 5 and the narrower part 35 of the hole 25 in the handle 2. In such case the hole in the retainer 5 is still in register with the narrowed portion 35 of the hole 25 in the handle 3, but the size or diameter of the combined registered hole or cavity in the retainer 5, the narrow portion 35 of hole 25, and hole 45 is effectively smaller than if the holes 45 and 65 are fully in register. In other words, if the hole 45 in the slide 40 is only partly in register with the hole 65 of the retainer and narrowed portion 35 of the hole 25, the diameter of the combined holes 65, 45, and 35 is restricted or lessened in diameter by, and at the location of, the partial registering of hole 45 with holes 65 and 35.

When the lid assembly and cookware are so assembled, the cookware, containing water and food to be cooked, is placed a stove or other heating surface and heated. As the liquid in the cookware increases in temperature, water vapor is formed in the cookware and increases the pressure of the air and water vapor inside the cookware. Eventually, the liquid contents of the cookware will boil, producing additional pressurized water vapor, air, and/or steam inside the cookware. The lid 2, however, does not rock or move off of the top of the cookware, because the silicone band 6 seals the lid 2 on the cookware. And, due to the friction of the band 6 against the inside of the cookware, the band 6 prevents the lid 2 from being dislodged from the top of the cookware.

Instead, the pressurized air, water vapor and/or steam in the cookware move upward though the hole 65 in the retainer 5, through the registered or partially registered holes 65 and 45 in the retainer 65 and slide 40, respectively, up though the narrowed portion 35 of the hole 25 in the handle 3, and out into the atmosphere above the lid 2. As the pressurized air, water vapor, and/or steam escapes through the registered or partly registered holes 65, 45, and 35, a whistling noise is produced by the rush of the air, water vapor, and/or steam through holes 65, 45, and 35. This whistling noise signals the user that the liquid in the cookware is boiling, so that the user can reduce the heat being applied to the cookware in order to permit cooking to continue at optimal cooking temperature.

The pitch and volume of the whistle may be controlled by adjusting the size of the combined registered holes 65, 45, and 35. Higher volume, lower pitch whistling may be produced by placing the holes 65 and 45 fully in register. Lower volume, higher pitch whistling may be produced by placing the holes 65, 45, and 35 only partly in register. Adjusting the size or diameter of the combined holes 65, 45, and 35 is accomplished by moving slide 40 to increase or decrease the size or diameter of the combined holes 65, 45, and 35 at the location of the partial or registration of hole 45 with holes 65 and 35. Thus, the user may adjust the whistling noise to the desired volume and pitch to most effectively signal or warn the user that the contents of the cookware are boiling and that the temperature of the stove or heating source to be reduced.

It is to be understood that while certain forms of the present invention have been illustrated and described herein, it is not to be limited to the specific forms or arrangement of parts described and shown.

1. A lid assembly for cookware comprising:
a lid having a top, a rim, and a flange extending downward from the rim;
a handle secured to the top of the lid; and
a removable flexible band extended around the flange of the lid.

2. The lid assembly of claim 1 wherein, when the lid is on the cookware, the band is in frictional, sealing contact with both the lid and the cookware such that pressurized air and water vapor inside the cookware can neither dislodge the lid nor escape from the cookware.

3. The lid assembly of claim 1 wherein the handle forms a central threaded longitudinal hole and is secured to the lid by a retainer with external threads that screws into the threaded hole in the handle through a central hole in the top of the lid.

4. The lid assembly of claim 1 wherein the handle contains a hole communicating with a interior of the cookware such that, when pressurized air and water vapor pass through the hole, a whistling sound is produced.

5. The lid assembly of claim 4 wherein a movable slide in the handle forms a hole which, when fully registered with the hole in the handle produces a higher volume whistle; when partly registered with the hole in the handle, produces a lower volume whistle; and when not registered with the hole in the handle, prevents pressurized air and water vapor from passing through the hole in the handle.

6. The lid assembly of claim 1 wherein the flexible band is made of silicone.

7. The lid assembly of claim 1 wherein the handle is secured to the lid by inserting an externally threaded retainer up through a central hole in the top of the lid and rotating the threaded retainer into a longitudinal threaded hole in the handle.

8. The lid assembly of claim 1 wherein, when the lid is on the cookware, the flexible band seals the lid on the cookware, preventing the lid from becoming dislodged when the heated contents of the cookware produce pressurized air and water vapor.

9. A lid assembly for cookware comprising:
a lid having a top, a rim, and a flange extending downward from the rim;
a handle secured to the top of the lid, the handle containing a whistle; and
a removable flexible band extended around the flange of the lid.

10. The lid assembly of claim 9 wherein, when the lid is on the cookware, the band is in frictional, sealing contact with both the lid and the cookware such that pressurized air and water vapor inside the cookware can neither dislodge the lid nor escape from the cookware.

11. The lid assembly of claim 9 wherein the handle forms an internally threaded longitudinal hole and is secured to the top of the lid by an externally threaded retainer that extends up through a central hole in the top of the lid and is screwed into the hole in the handle.

12. The lid assembly of claim 9 wherein the whistle is formed by a hole in the handle that communicates with the inside of the cookware, the whistle making an audible sound when pressurized air and water vapor pass though the hole.

13. The lid assembly of claim 12 wherein a movable slide in the handle forms a hole which, when fully registered with the hole in the handle produces a higher volume whistle; when partly registered with the hole in the handle, produces a lower volume whistle; and when not registered with the hole in the handle, prevents pressurized air and water vapor from being exhausted from the hole in the handle.

14. The lid assembly of claim 9 wherein the flexible band is made of silicone.

15. The lid assembly of claim 1 wherein, when the lid is on the cookware, the flexible band seals the lid to the cookware, preventing the lid from becoming dislodged when the heated contents of the cookware produce pressurized air and water vapor.

16. A lid assembly for cookware comprising:
a lid having a top, a rim, and a flange extending downward from the rim;
a removable flexible band extended around the flange of the lid;
wherein, when the lid is on the cookware, the band provides a friction fit between the lid and the cookware such that pressurized air and water vapor in the interior of the cookware can neither escape from the cookware nor dislodge the lid from the cookware.

17. The lid assembly of claim 16 wherein a handle having a whistle is secured to the top of the lid, the whistle emitting an audible sound when pressurized air and water vapor pass though it.

18. The lid assemble of claim 16 wherein a handle is secured to the top of the lid, the handle having a central longitudinal hole in communication with the interior of the cookware such that when pressurized air and water vapor pass through the hole, an audible sound is emitted.

19. The lid assembly of claim 18 wherein a movable slide in the handle forms a hole which, as it is moved into and out of register with the hole in the handle, respectively increases and decreases the volume of the audible sound.

20. The lid assembly of claim 16 wherein a handle is secured to the top of the lid by inserting an externally threaded retainer up through a central hole in the top of the lid and rotating the threaded retainer into a longitudinal threaded hole in the handle.
